(19) United States
(12) Patent Application Publication
(10) Pub. No.: US 2024/0048826 A1
(43) Pub. Date: Feb. 8, 2024

(54) CAMERA DEVICE, CAMERA DEVICE HEATING MODULE AND METHOD

(71) Applicant: FLYTECH TECHNOLOGY CO., LTD., Taipei City (TW)

(72) Inventors: LI-CHUN CHOU, Taipei City (TW); TIEN-HSIEN FENG, Taipei City (TW); YU-CHENG LIN, Taipei City (TW)

(21) Appl. No.: 18/088,950

(22) Filed: Dec. 27, 2022

(30) Foreign Application Priority Data
Aug. 3, 2022 (TW) 111129226

(51) Int. Cl. H04N 23/52; G01K 7/22; G02B 7/02; H05B 1/02

(52) U.S. Cl. CPC H04N 23/52; G01K 7/22; G02B 7/028; H05B 1/0205

(57) ABSTRACT

The present invention relates to a camera device heating module. The module includes a set of soft electric heater; and a control circuit block configured to electrically connected with and control the set of soft electric heater and including a low-temperature heating switch unit including a low-temperature protecting circuit having a positive temperature coefficient and connected with the set of soft electric heater; an over-temperature turnoff switch unit including an over-temperature protecting circuit having a negative temperature coefficient and connected with the set of soft electric heater; and a microcontroller unit electrically connected with the low-temperature heating switch unit and the over-temperature turnoff switch unit.

### CROSS-REFERENCE TO RELATED APPLICATION

This application claims priority benefit to Taiwan Invention Patent Application Serial No. 111129226, filed on Aug. 3, 2022, in Taiwan Intellectual Property Office, the entire disclosures of which are incorporated by reference herein.

### FIELD

The present invention relates to a camera device, camera device heating module and method, in particular to a camera device, camera device heating module and method using a duo security protection mechanism having a low-temperature actively heating component and process and an over-temperature actively turning off component and process.

### BACKGROUND

In a conventional technology, a suit of basic digital camera equipment usually consists of at least one set of lens assembly arranged at the front end and being capable of projecting the front scene onto the focal point behind and imaging it on the focal point within the field of view, an image sensor configured at the physical focal point and continuously capturing the imaging by a fixed frame rate on the time line, and an image signal processor (ISP) chip. In general, a conventional digital video camera equipment is powered by a built-in energy storage device or alternatively acquires an electric power from the outside through a connecting port, and output the filmed video through the same connecting port. The digital video camera equipment is extensively applied in a variety of fields nowadays.

The image sensors and the image signal processor chips built inside the equipment are all temperature-sensitive components. The upper and lower bounds of the working temperature for these temperature-sensitive devices are typically in a range between 0° C. to 80° C. If and when these devices are subjected to a temperature over its upper bound, they generate noise signals that are hardly filtered out, as well as if and when these devices are subjected to a temperature lower than its lower bound, they are disabled temporarily resulting in malfunctions. Ideally, it is better to render these devices working and operating around the room temperature, which is a temperature about 20° C., or lower, since these devices have a good heat dissipation around room temperature or lower so to keep the normal operation.

In any event, there are many countries situated in the cold zones around the world, and the ambient temperature out there is lower or much lower than the freezing point of water of 0° C. at most times over the year. If a digital camera equipment is required to expose to such a harsh cold environment, the cold and wet air straightforwardly causes the lens and electronic components inside the equipment frosted, fogged or frozen, which blocks out a small part of the field of vision for some mild cases but causes the lens broken in some severe cases. Thus, without configuring with additional heating accessories, the conventional digital camera equipment can hardly operate normally in both outdoor or even indoor fields in these cold zones.

In addition, when the conventional digital camera equipment is applied in some fields with rapidly changing climates, the lens contained in the equipment is often fogged due to the temperature difference between the external environment and the internal space inside the main body of the camera equipment, which results in the filmed video becoming blurry and unclear. In this regard, if the digital camera equipment is used as an onboard camera and configured outside the vehicle, the fogging over the lens directly jeopardize the driver and driving safety.

Hence, there is a need to solve the above deficiencies/issues.

### SUMMARY

The present invention relates to a camera device, camera device heating module and method, in particular to a camera device, camera device heating module and method using a duo security protection mechanism having a low-temperature actively heating component and process and an over-temperature actively turning off component and process.

Accordingly, the present invention provides a camera device heating module. The module includes a set of soft electric heater; and a control circuit block configured to electrically connected with and control the set of soft electric heater and including a low-temperature heating switch unit including a low-temperature protecting circuit having a positive temperature coefficient and connected with the set of soft electric heater; an over-temperature turnoff switch unit including an over-temperature protecting circuit having a negative temperature coefficient and connected with the set of soft electric heater; and a microcontroller unit electrically connected with the low-temperature heating switch unit and the over-temperature turnoff switch unit.

Preferably, the set of soft electric heater further includes one of a first soft electric heater configured at one side of an image processing module included in a camera device, wherein the image processing module includes an image signal processor; and a second soft electric heater configured at an unviewable area out of a field of view of a lens included in the camera device.

Preferably, the low-temperature heating switch unit is configured to switch to enter into a conductive status to permit an electric current flowing into the set of soft electric heater when a space temperature is lower than a heating temperature; the over-temperature turnoff switch unit is configured to switch to enter into a cutoff state to cease the electric current flowing into the set of soft electric heater when a space temperature is greater than an over-heat temperature; the low-temperature heating switch unit takes over a power of control for the set of soft electric heater prior to the microcontroller unit, when the space temperature is lower than the heating temperature; the over-temperature turnoff switch unit takes over the power of control for the set of soft electric heater prior to the microcontroller unit, when the space temperature is greater than the over-heat temperature; or the microcontroller unit takes over the power of control for the set of soft electric heater prior to the low-temperature heating switch unit and the over-temperature turnoff switch unit, when the space temperature is in a range between the heating temperature and the over-heat temperature.

The present invention further provides a camera device. The device includes: a lens; and a camera device heating module, including: a set of soft electric heater; and a control circuit block electrically connected with, configured to control the set of soft electric heater and including: a low-temperature heating switch unit including a low-temperature protecting circuit having a positive temperature coefficient and connected with the set of soft electric heater; an over-temperature turnoff switch unit including an over-temperature protecting circuit having a negative temperature coefficient and connected with the set of soft electric heater; and a microcontroller unit electrically connected with the low-temperature heating switch unit and the over-temperature turnoff switch unit.

Preferably, the camera device further includes one of: the lens having a viewable area with a field of view and an unviewable area without the field of view; an image processing module including an image signal processor; and the set of soft electric heater further including: a first soft electric heater configured at one side of the image processing module; a second soft electric heater configured at the unviewable area; and a light-transmittable protecting cover including a first surface, wherein the second soft electric heater is configured within the unviewable area by attaching to the first surface.

The present invention further provides a camera device heating method. The method includes configuring a set of soft electric heater in a camera device; configuring in the camera device a low-temperature heating switch unit including a low-temperature protecting circuit having a positive temperature coefficient and connected with and controlling the set of soft electric heater; configuring in the camera device an over-temperature turnoff switch unit including an over-temperature protecting circuit having a negative temperature coefficient and connected with and controlling the set of soft electric heater; and configuring in the camera device a microcontroller unit electrically connected with the low-temperature heating switch unit and the over-temperature turnoff switch unit.

The above content described in the summary is intended to provide a simplified summary for the presently disclosed invention, so that readers are able to have an initial and basic understanding to the presently disclosed invention. The above content is not aimed to reveal or disclose a comprehensive and detailed description for the present invention, and is never intended to indicate essential elements in various embodiments in the present invention, or define the scope or coverage in the present invention.

### DESCRIPTION OF THE DRAWINGS

A more complete appreciation of the invention and many of the attendant advantages thereof are readily obtained as the same become better understood by reference to the following detailed description when considered in connection with the accompanying drawing, wherein:

FIG. 1 is a schematic diagram illustrating the camera device including the camera device heating module according to the present invention;

FIG. 2 is a side-view cross-sectional schematic diagram illustrating the first embodiment for the camera device including the camera device heating module according to the present invention;

FIG. 3 is a cross-sectional schematic diagram illustrating the cross sectional profile along the cross section line of LL′ as shown in FIG. 2 in the first embodiment for the camera device including the camera device heating module according to the present invention;

FIG. 4 is a front-view structural schematic diagram illustrating the camera device including the camera device heating module according to the present invention;

FIG. 5 is a side-view cross-sectional schematic diagram illustrating the second embodiment for the camera device including the camera device heating module according to the present invention;

FIG. 6 is a cross-sectional schematic diagram illustrating the cross sectional profile along the cross section line of JJ′ as shown in FIG. 5 in the second embodiment for the camera device including the camera device heating module according to the present invention;

FIG. 7 is a block schematic diagram illustrating the circuit layout for the camera device heating module according to the present invention;

FIG. 8 is a block schematic diagram illustrating the operation of the camera device heating module according to the present invention;

FIG. 9 is a system diagram illustrating the network-based surveillance video system according to the present invention;

FIG. 10 is a schematic histogram illustrating the incremental change of the electric current per time-divided interval by the implementation of the electric current distributing step according to the present invention;

FIG. 11 is a flow chart showing the implementation steps for the camera device heating method according to the present invention;

FIG. 12 is a flow chart showing the implementation steps for the fogging identifying method according to the present invention; and

FIG. 13 is a flow chart showing the implementation steps for the power allocating method according to the present invention.

### DETAILED DESCRIPTION

The present disclosure will be described with respect to particular embodiments and with reference to certain drawings, but the disclosure is not limited thereto but is only limited by the claims. The drawings described are only schematic and are non-limiting. In the drawings, the size of some of the elements may be exaggerated and not drawn on scale for illustrative purposes. The dimensions and the relative dimensions do not necessarily correspond to actual reductions to practice.

It is to be noticed that the term “including”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device including means A and B” should not be limited to devices consisting only of components A and B.

The disclosure will now be described by a detailed description of several embodiments. It is clear that other embodiments can be configured according to the knowledge of persons skilled in the art without departing from the true technical teaching of the present disclosure, the claimed disclosure being limited only by the terms of the appended claims.

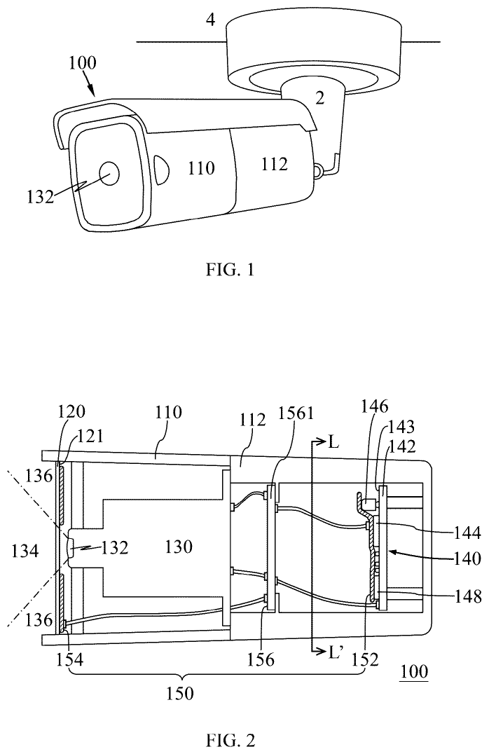

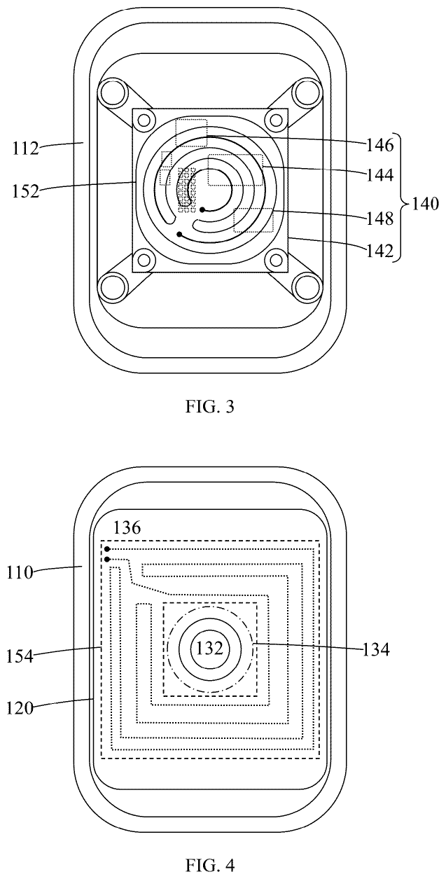

FIG. 1 is a schematic diagram illustrating the camera device including the camera device heating module according to the present invention. FIG. 2 is a side-view cross-sectional schematic diagram illustrating the first embodiment for the camera device including the camera device heating module according to the present invention. FIG. 3 is a cross-sectional schematic diagram illustrating the cross sectional profile along the cross section line of LL′ as shown in FIG. 2 in the first embodiment for the camera device including the camera device heating module according to the present invention. FIG. 4 is a front-view structural schematic diagram illustrating the camera device including the camera device heating module according to the present invention. In the first embodiment, the camera device 100 including the camera device heating module according to the present invention is preferably secured onto any designated mounting point 4, for example, a bracket, a base, a platform, a wall or a ceiling, etc., through a universal rotatable mount 2.

The camera device 100 includes modules, such as, a housing consisting of a front housing 110 and a rear housing 112, at least a light-transmittable protective cover 120 protected and contained in the housing, a camera module 130, an image processing module 140 and a camera device heating module 150, wherein the image processing module 140 is electrically connected with the camera module 130, and includes electronic components, such as, at least an image processing circuit board 142, an image signal processor 144, an electronic oscillator 146 and a read-only memory 148.

The camera module 130 includes a lens 132 for optically imaging and an image sensor component, such as, a CMOS, configured at a position behind the lens 132 with an appropriate distance to sense and capture the imaging formed by the lens 132. The CMOS consists of a matrix of two-dimensional optical sensing pixels receiving and sensing the intensity and color of an incident light according to the arrangement of the two-dimensional pixel in the matrix and converting it into a corresponding electronic image signal. The CMOS continuously generates electronic image signals forming animations consisting of multiple frames by capturing the two-dimensional imaging with a fixed frame rate on the time axis. The image signal processor 144 receives these electronic image signals, performs operations including the color processing, the noise reduction and the compression, and outputs a complete video.

The camera module 130 captures multiple two-dimensional images occurring within a viewable area 134 defined by the optical field of view (FOV) in front of the lens 132. The images occurring in an unviewable area 136 out of the field of view of the lens 132 fail to be captured by the camera module 130. The light-transmittable protective cover 120 is arranged in front of the lens 132 and toward the filming direction, and thus the light-transmittable protective cover 120 is correspondingly distinguished into the viewable area 134 and the unviewable area 136 as well.

The image signal processor 144, the electronic oscillator 146 and the read-only memory 148 included in the image processing module 140 are all the important components. In general, the electronic oscillator 146 determines the clock rate or the clock cycles per second, the read-only memory 148 stores the important firmware coding, and the image signal processor 144 is the critical component to generate the video, which the components are temperature sensitive as well at the same time. For example, the image signal processor 144 is preferable to operate with a working temperature in a range between 0° C. to 80° C. Any temperature out of the working temperature range may possibly cause the image signal processor 144 disabled temporarily, which renders the camera device 100 ceased to operate. There are many countries over the world are situated in the cold zones where the ambient temperature is lower than 0° C. most of time. If the camera device 100 is intended to operate in these cold zones, it can hardly operate normally.

Furthermore, if there is a significant temperature difference existing between the internal space inside the camera device 100 and the external environment lasting for a long period of time, such the temperature difference causes the lens 132 fogging up. The fog may form and distribute inside or outside the lens 132, rendering the captured image blurry. For example, when the camera device 100 is used as an onboard camera and configured outside the vehicle, the lens 132 is easily fogged up in cold and wet winters or rainy days due to the lasting significant temperature difference incurred by the heat dissipated by a chip under work and the external cold air. Likewise, the camera device 100 deployed in a kitchen room or configured inside a refrigerator is prone to fogging over the lens 132 due to the temperature difference between the inside and outside spaces.

Therefore, the camera device 100 according to the present invention further includes a set of camera device heating module 150 inside. The camera device heating module 150 includes a set of soft electric heater and a control circuit block 156. The set of soft electric heater includes a first soft electric heater 152 and a second soft electric heater 154. The respective first soft electric heater 152 and second soft electric heater 154 are preferably a soft electric heater plate, such as, a PET film heater, a PI film heater, a silicone rubber heater, a mica heater, a transparent film heater, a graphene heater, a ceramic heater, a non-woven soft heater, an aluminum foil heater, a fabric heater, etc., have a minimum bend radius, such as, not less than 1 mm, and bendable, deflectable, flexible and deformable so to attach to any irregular surfaces.

In the first embodiment, the first soft electric heater 152 is preferably attached to one side the image processing module 140 has, for example, the image processing circuit board front surface 143 included in the image processing circuit board 142, i.e., the device surface or the non-soldering surface, as shown in FIG. 2 and FIG. 3. The first soft electric heater 152 is capable of heating up all part or a part of components included in the image processing circuit board 142, the control circuit block 156, and the camera module 130 contained inside the camera device 100, subject to the intelligent control from the control circuit block 156.

For example, the first soft electric heater 152 is conformably attached to the surfaces of the image signal processor 144, the electronic oscillator 146 or the read-only memory 148 by adhesive or bonding means for example. Because the respective components such as the image signal processor 144, the electronic oscillator 146, and the read-only memory 148 have different respective component sizes, the image processing circuit board front surface 143 formed thereby may not be a flat surface but an irregular surface with multiple height differences or steps. The first soft electric heater 152 that is bendable, deflectable, flexible or deformable is capable of overcoming these multiple high differences and being conformably attached onto the image processing circuit board front surface 143 and directly contacts with the temperature-sensitive devices, such as, the image signal processor 144, the electronic oscillator 146 and the read-only memory 148.

In the first embodiment, the second soft electric heater 154 is preferably attached to the unviewable area 136 by attaching to one side the light-transmittable protective cover 120 has, for example, the inner side 121 of the light-transmittable protective cover 120 closer to the lens 132, lest it should interfere with the filming operation of the lens 132, as shown in FIG. 2 and FIG. 4. The second soft electric heater 154 is capable of heating up the adjacent space next to the lens 132 and the light-transmittable protective cover 120 subject to the intelligent control from the control circuit block 156.

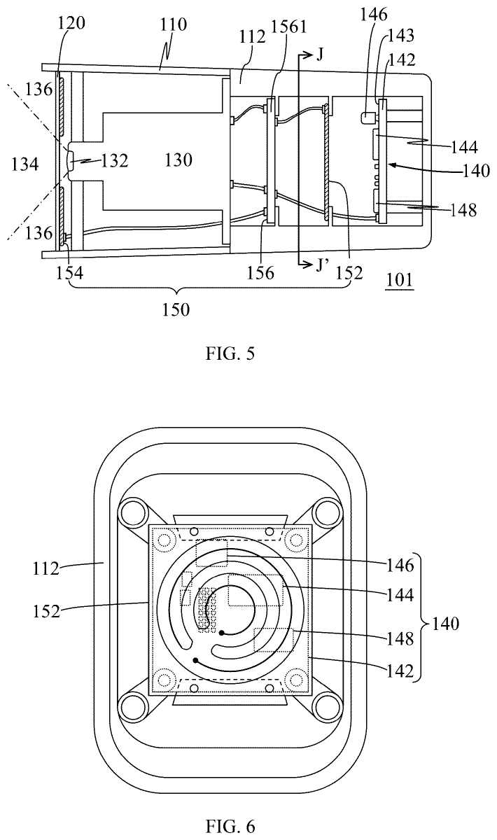

FIG. 5 is a side-view cross-sectional schematic diagram illustrating the second embodiment for the camera device including the camera device heating module according to the present invention. FIG. 6 is a cross-sectional schematic diagram illustrating the cross sectional profile along the cross section line of JJ′ as shown in FIG. 5 in the second embodiment for the camera device including the camera device heating module according to the present invention. In the second embodiment, the camera device 101 including the camera device heating module 150 according to the present invention is based on the first embodiment and includes all the technical features of the first embodiment.

In the second embodiment, the first soft electric heater 152 is preferably configured in the space existing between the control circuit block 156 and the image processing module 140 by for example attaching to the rear housing 112 to dispose between the control circuit block 156 and image processing module 140, as shown in FIG. 5 and FIG. 6. The first soft electric heater 152 is capable of heating up all part or a part of the control circuit block 156, the image processing circuit board 142, and the camera module 130 contained inside the camera device 100, subject to the intelligent control from the control circuit block 156.

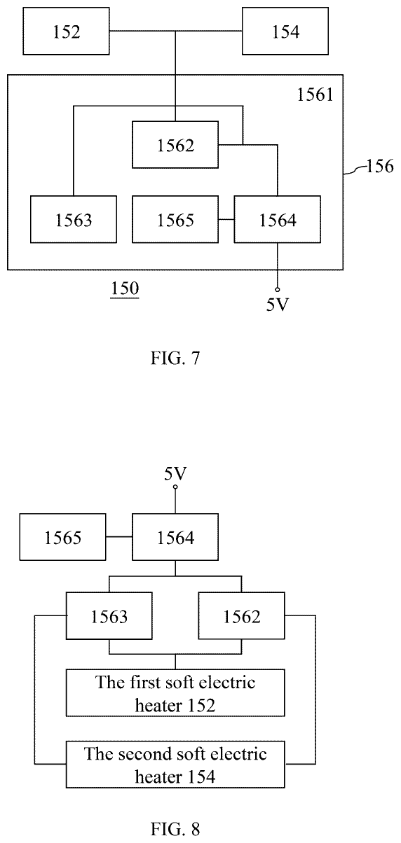

FIG. 7 is a block schematic diagram illustrating the circuit layout for the camera device heating module according to the present invention. FIG. 8 is a block schematic diagram illustrating the operation of the camera device heating module according to the present invention. The camera device heating module 150 includes a first soft electric heater 152, a second soft electric heater 154, and a control circuit block 156. The control circuit block 156 includes a control circuit board 1561 and at least a low-temperature heating switch unit 1562 based on a positive temperature coefficient (PTC) thermistor, an over-temperature turnoff switch unit 1563 based on negative temperature coefficient (NTC) thermistor, a microcontroller unit (MCU) 1564 and a temperature sensor 1565 that are assembled onto the control circuit board 1561 at the position as shown in FIG. 7 by methods such as but not limited to a surface mount technology (SMT) or soldering process. The MCU 1564 is electrically connected with the low-temperature heating switch unit 1562, the over-temperature turnoff switch unit 1563, and the temperature sensor 1565. The low-temperature heating switch unit 1562 and the over-temperature turnoff switch unit 1563 are electrically connected with the first soft electric heater 152 and the second soft electric heater 154. An electric power, such as but not limited to, a voltage of 5V, is supplied to the MCU 1564 and the low-temperature heating switch unit 1562 through such as but not limited to a USB port.

In this embodiment, two types of temperature thresholds, the heating temperature and the over-heat temperature are disclosed. The heating temperature is preferably given as for example but not limited to, 0° C., 10° C., 20° C. or 30° C., etc. The over-heat temperature is preferably given as for example but not limited to, 50° C., 70° C. or 80° C., etc. Accordingly, the space temperature is at least distinguished into three zones including the heating protection zone, the safe working zone and the over-heat protection zone. The heating protection zone is referred to the temperature range that is below the heating temperature. The over-heat protection zone is referred to the temperature range that is higher than the over-heat temperature. The safe working zone is referred to the temperature range that is in a range of between the heating temperature and the over-heat temperature. Alternatively, the heating temperature is preferably regarded as a first temperature threshold as well as the over-heat temperature is preferably regarded as a second temperature threshold.

The low-temperature heating switch unit 1562 includes at least one PTC thermistor whose resistance value increases as the temperature rises and is preferably in direct proportion to the ascending of temperature. The selection for PTC thermistor is preferable to fulfill the following requirements. The Curie point temperature or switching temperature of the PTC thermistor is preferably the same with the heating temperature, such as, 0° C., 10° C., 20° C. or 30° C. When the PTC thermistor itself has the temperature higher than the heating temperature, its electric impedance is induced to rise up and blocks the electric current to pass through, and when the PTC thermistor itself has the temperature lower than the heating temperature, its electric impedance is induced to descend down and renders the electric current flowing through. Thus, when the PTC thermistor material detects that the current temperature is lower than the heating temperature, it allows the electric current to pass through the low-temperature heating switch unit 1562 and flow to the first soft electric heater 152 and the second soft electric heater 154, to drive the first soft electric heater 152 and the second soft electric heater 154 heated up.

The over-temperature turnoff switch unit 1563 includes at least one NTC thermistor whose resistance value decreases as the temperature drops and is preferably in inverse proportion to the descending of temperature, and a MOS switch including at least one PMOS or one NMOS. The selection for NTC thermistor is preferable to fulfill the following requirements. The Curie point temperature or switching temperature of the NTC thermistor is preferably the same with the over-heat temperature, such as, 50° C., 60° C., 70° C. or 80° C. When the NTC thermistor itself has the temperature higher than the over-heat temperature, its electric impedance is induced to descend down and renders the electric current flowing through, and when the NTC thermistor itself has the temperature lower than the over-heat temperature, its electric impedance is induced to rise up and blocks the electric current to pass through. Thus, when the NTC thermistor material detects that the current temperature is higher than the over-heat temperature, it enables the MOS switch included in the over-temperature turnoff switch unit 1563 to enter into the cutoff state, to cease the electric current flowing to the first soft electric heater 152 and the second soft electric heater 154 through over-temperature turnoff switch unit 1563 to desist the first soft electric heater 152 and the second soft electric heater 154 from heating.

The operation of the low-temperature heating switch unit 1562 and the over-temperature turnoff switch unit 1563 are totally independent of the MCU 1564. When the space temperature inside the housing of the camera device 100 is lower than the heating temperature and enters into the heating protection zone or is higher than the over-heat temperature and enters into the over-heat protection zone, the low-temperature heating switch unit 1562 and the over-temperature turnoff switch unit 1563 acquire the power of control to take over the first soft electric heater 152 and the second soft electric heater 154 prior to the MCU 1564.

When the space temperature inside the housing of the camera device 100 is lower than the heating temperature, the low-temperature heating switch unit 1562 enters into the conductive state because of the descending of the electric impedance of the PTC thermistor component and actively forwards electric power to the first soft electric heater 152 and the second soft electric heater 154 by bypassing the MCU 1564. Therefore, the first soft electric heater 152 and the second soft electric heater 154 are heated up to heat the camera device 100.

When the temperature recovers back to the heating temperature, the low-temperature heating switch unit 1562 ceases the forwarding of the electric power to the first soft electric heater 152 and the second soft electric heater 154 due to the ascending of the electric impedance. At this time, the MCU 1564 acquires the power of control to take over the first soft electric heater 152 and the second soft electric heater 154.

When the temperature is higher than the overheating temperature, the over-temperature turnoff switch unit 1563 enters into the conductive state because of the descending of the electric impedance of the NTC thermistor component and renders the MOS switch inside switched to the cutoff state, the electric current supplied from the MCU 1564 to the first soft electric heater 152 and the second soft electric heater 154 through the forwarding of the over-temperature turnoff switch unit 1563 is ceased to desist the first soft electric heater 152 and the second soft electric heater 154 from heating.

In this regard, when the space temperature inside the housing of the camera device 100 enters into the heating protection zone or the over-heat protection zone, the low-temperature heating switch unit 1562 and the over-temperature turnoff switch unit 1563 bypass the MCU 1564 and directly take control of the first soft electric heater 152 and the second soft electric heater 154, to straightforwardly activate the heating operation for the camera device 100 to prevent the camera device 100 from suspending because of the low temperature inside or deactivate all the heating operations for the camera device 100 to prevent the camera device 100 from suspending because of the high temperature inside respectively.

When the space temperature is in the safe working zone existing between the heating temperature and the over-heat temperature, the MCU 1564 takes the power of control of the first soft electric heater 152 and the second soft electric heater 154 and adjusting the temperature. Subsequently the MCU 1564 included in the camera device heating module 150 acquires the power of control to decide whether it is to activate the filming function of the camera module 130 or not, and return the measured temperature, the video, the power supply conditions back to the system for data collection and integration.

In terms of MCU, if the MCU 1564 has a working temperature in a range between the minimum working temperature and the maximum working temperature, 0° C. to 80° C. for example, the heating temperature is preferably set to be equal to or a little greater than the minimum working temperature, in order to commence the heating operation before the temperature of MCU 1564 itself drops down to the minimum working temperature, and the over-heat temperature is preferably set to be a little less than the maximum working temperature, in order to cease the heating operation to reduce the space temperature before the temperature of MCU 1564 itself ascends up to the maximum working temperature.

In addition, since the camera device 100 further contains the other electronic components, chips and temperature-sensitive devices inside, it is better to further take the minimum and maximum working temperatures these devices have into account when setting up the heating temperature and over-heat temperature.

Technically, when the MCU 1564 itself has a temperature lower than the minimum working temperature, it turns off automatically. At this time, the camera device 100 is usually regarded as entering into a low-temperature protection mode to cease operating temporarily. Thus, by bypassing the MCU 1564, if and when the space temperature indeed approaches and drops below the minimum working temperature, the low-temperature heating switch unit 1562 takes over to directly activate the first soft electric heater 152 and the second soft electric heater 154 to perform the heating operations to increase the space temperature. When the space temperature rises up and above the minimum working temperature, the MCU 1564 boots up on and commences detecting the space temperature through the temperature sensor 1565. When the space temperature detected by the temperature sensor 1565 is a little higher than the heating temperature, the MCU 1564 takes control of all kinds of operations again.

When the space temperature approaches to the over-heat temperature but yet to reach up the maximum working temperature, the over-temperature turnoff switch unit 1563 desists all the heating operation performed by the first soft electric heater 152 and the second soft electric heater 154 inside the camera device 100 to reduce the entire space temperature to protect the electronic components from thermal failure and prevent the camera device 100 from suspending due to the high internal temperature. At this time, the camera device 100 is regarded as entering into an over-heat protection mode.

For example, it assumes that the ambient temperature is −20° C., the heating temperature is 0° C. and the over-heat temperature is 60° C., the minimum working temperature of the MCU 1564 is 0° C. and the maximum working temperature is 80° C. When the camera device 100 is in a full cold condition, the system acquires an electric power of 5V through the USB port. The PTC thermistor included in the low-temperature heating switch unit 1562 operates normally to detect the internal space temperature. Because the space temperature is lower than 0° C., the PTC thermistor directly enters into the conductive state and forwards the 5V electric power sourced from the USB port to the first soft electric heater 152 and the second soft electric heater 154 for performing a preheating operation.

After preheating operation, the space temperature returns to around 0° C., and the MCU 1564 boot up on automatically and takes a full control to activate the temperature sensor 1565 to detect the space temperature. After the MCU 1564 confirms that the space temperature has returned to and above 0° C., the MCU 1564 sends a command to desist the electric power supply to the low-temperature heating switch unit 1562, and decides whether it is to activate the USB signal to turn on the video recording function of the camera module 130.

When the space temperature rises up to 60° C., the reasons to cause the space temperature rose up include but not limited to the thermal failure of the first soft electric heater 152 or the second soft electric heater 154 or some other high-temperature events, such as, a fire incident or a short circuit accident, etc. No matter what reasons cause the temperature to rise up, when the space temperature approaches around 60° C., the over-temperature turnoff switch unit 1563 directly take over to desist the power supply transmitted to the first soft electric heater 152 and the second soft electric heater 154, to prevent the camera device 100 from being overheated by the first soft electric heater 152 and the second soft electric heater 154 and the derived safety problems thereof, and protect the electronic circuits contained inside the camera device 100 at the same time.

When the temperature is within the safe working zone, the MCU 1564 reboots up and operates normally. The programmed MCU 1564 has embedded with a fogging identifying method, which the method is capable of automatically and intelligently distinguishing whether the lens 132 is indeed fogging or not. Subject to the condition that it is determined that the lens 132 is indeed fogging, the second soft electric heater 154 is activated to perform a defogging heating operation for the lens 132, the light-transmittable protective cover 120 and the adjacent space, so to eliminate the fog spreading over the lens 132, the light-transmittable protective cover 120 and the adjacent space.

The fogging identifying method performed by the MCU 1564 at least includes a multi-device image sampling step, an image sharpness rate of change estimation step, a fogging determining step and a defogging heating step, etc. The fogging identifying method is conducted on the basis of comparing the image sharpness rates of change among multiple camera devices connected through the network to determine whether the lens 132 is indeed fogging.

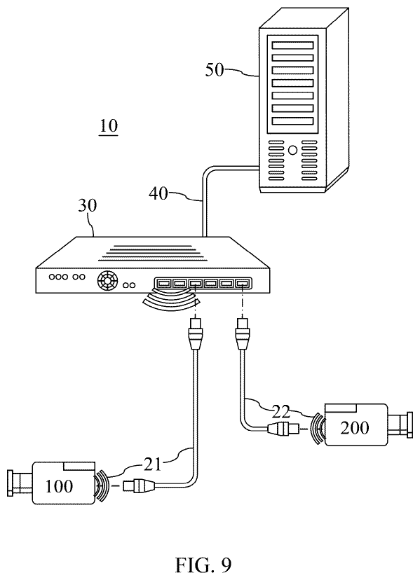

FIG. 9 is a system diagram illustrating the network-based surveillance video system according to the present invention. In this embodiment, the camera device 100 is included in a network-based surveillance video system 10. The network-based surveillance video system 10 further includes another second camera device 200, a system box 30 and a remote server 50. Each camera devices 100 and 200 are connected to the system box 30 through the respective communication transmission channels 21-22. The system box 30 is connected to the remote server 50 through the internet transmission channel 40. The communication transmission channels 21-22 are preferably a wired transmission channel or a wireless transmission channel. The camera device 100 and the second camera device 200 are preferably deployed in the same venue.

Firstly, in the multi-device image sampling step, a fogging identifying sampling time interval, such as, 10 seconds, 15 seconds, 20 seconds, 30 seconds, 45 seconds or 60 seconds, etc., is set for the first camera device 100 and the second camera device 200 by operating the built-in MCU 1564 in the camera device 100 and the built-in MCU in the second camera device 200. Then, the first camera device 100 and the second camera device 200 are commanded to cyclically sample and send back the captured image frames to the remote server 50 at the beginning and the end of the sampling time interval respectively, based on the fogging identifying sampling time interval.

In the image sharpness rate of change estimation step, a fogging identifying algorithm that is executable by the server processor is pre-established on the remote server 50. The fogging identifying algorithm is configured to receive the first camera device first image sampled by the camera device 100 at the beginning of the fogging identifying sampling time interval and the first camera device second image sampled at the end of the fogging identifying sampling time interval, compute the first image sharpness for the first camera device first image and the second image sharpness for the first camera device second image respectively, and then compute the discrepancy between the first image sharpness and the second image sharpness as the first camera device image sharpness rate of change.

Likewise, the fogging identifying algorithm is configured to receive the second camera device first image sampled by the second camera device 200 at the beginning of the fogging identifying sampling time interval and the second camera device second image sampled at the end of the fogging identifying sampling time interval, compute the first image sharpness of the second camera device first image and the second image sharpness of the second camera device second image respectively, and then compute the discrepancy between the first image sharpness and the second image sharpness as the second camera device image sharpness rate of change.

Next, in the fogging determining step, the fogging identifying algorithm is configured to compute the discrepancy between the first camera device image sharpness rate of change and the second camera device image sharpness rate of change as a degree of fogging, and determine whether the degree of fogging is greater than a fogging threshold, for example, 5%, 10% or 20%. When the degree of fogging is greater than the fogging threshold, it determines that the lens 132 on the camera device is indeed fogging. When the degree of fogging is less than the fogging threshold, it determines that the lens 132 of the camera device is not fogging.

The logic of fogging identifying implied in the fogging identifying algorithm according to the present invention is that: if two or more sets of different lenses independent from each other configured in the same venue encounter the same situation that the image sharpness reduced within the same time period, that is the degree of fogging is less than the fogging threshold, the system determines the fogging phenomena occurring on both lens are resulted from the foggy environment and prohibits the activation of the defogging heating operation. Otherwise, when only the lens 132 on the camera device 100 encounters the situation the image sharpness reduced within the time period, that is the degree of fogging is greater than the fogging threshold, the system determines that the lens 132 is indeed fogging and commences to activate the defogging heating operation for the lens 132.

In the defogging heating step, when the fogging identifying algorithm confirms and determines that the lens 132 on the camera device 100 is indeed fogging, a heating command is sent to the MCU 1564 on the camera device 100 from the remote server 50, to instruct the MCU 1564 to activate the second soft electric heater 154 to perform the defogging heating operation. The defogging heating operation is preferably performed by a mode of time division multiple segment.

In some embodiments, the defogging heating operation may probably be performed subject to the condition the space temperature inside the camera device 100 is already high, for example, a condition which the temperature sensor 1565 detects the ambient temperature inside the camera device 100 is over 50° C., which is so close to the over-heat temperature. Nonetheless, the fogging identifying algorithm may also probably determine the lens 132 on the camera device 100 is indeed fogging. Therefore, once the temperature sensor 1565 detects that the temperature has risen up to 55° C. after the second soft electric heater 154 performs the defogging heating operation, even if the fogging identifying algorithm determines the lens 132 on the camera device 100 is indeed fogging, the MCU 1564 sends out a control signal to cease the defogging heating operation performed by the second soft electric heater 154. When the temperature sensor 1565 detects the ambient temperature has dropped down to 54° C., the MCU 1564 sends out a control signal to resume the defogging heating operation by the second soft electric heater 154 to protect the camera device 100, in particular to prevent the CMOS chip from exposing to a high temperature environment, because the heat is the ace killer to the image sensor. The image sensor generates noise signals that are hardly removed as the temperature goes higher.

When the temperature varies within the safe working zone, the MCU 1564 boots up to operate automatically. The programmed MCU 1564 has embedded with a power allocating method. Because the camera device 100 is powered by the USB transmission interface, and the heating operation performed by the camera device heating module 150 and the filming operation performed by the camera module 130 consume a lot of power, it is better to perform the heating operations including the fogging heating operation in a mode of time division multiple segment, to avoid the condition the electric current outputted from the USB transmission interface is insufficient for supplying both modules 130 an 150 at the same time. The execution of the power allocating method is capable of balancing and allocating the proportion of the electric current between the camera device heating module 150 and the camera module 130 according to the current conditions, to effectively prevent the power outage caused by the power supply overload for the USB transmission interface.

The power allocating method at least includes a temperature difference sampling step, a redundant power estimation step, and an electric current distributing step, etc. Firstly, the power allocating method is performed to confirm the current temperature. If the current temperature is within a cease-heating temperature zone, such as, a range between 0° C.-30° C., the power allocating method is not put into execution. If the current temperature is not within a cease-heating temperature zone, such as, a range between 0° C.-30° C., the execution of the power allocating method is then activated to perform the temperature difference sampling step.

In the temperature difference sampling step, a temperature difference sampling time interval is set for the first camera device 100, such as, 5 minutes, 10 minutes, 15 minutes, 20 minutes, etc., by operating the built-in MCU 1564 in the camera device 100. The first camera device 100 is commanded to cyclically sample the first temperature detected by the temperature sensor 1565 at the beginning of the temperature difference sampling time interval and the second temperature at the end of the temperature difference sampling time interval respectively, based on the temperature difference sampling time interval, and then compute the temperature difference between the first temperature and the second temperature.

In the redundant power estimation step, when the temperature difference is greater than the temperature threshold, such as, 5° C., the MCU 1564 commences to acquire the condition of power supply for the USB transmission interface, such as, by calculating the current value of voltage or the current value of electric current, determine whether the current value of voltage or the current value of electric current exceeds the safety range of the preset voltage and current value, and compute the current available redundant voltage or current available redundant electric current accordingly.

In the electric current distributing step, on the basis of the electric current, the MCU 1564 is configured to draw out a small part of the redundant electric current as the heating electric current in a quantitative or non-quantitative increment basis with the incremental ratio, such as, 5%, 10% or 15% of the redundant electric current, by a time-divided and multiple segmented step mode based on a gradually heating time interval, such as, 0.5 seconds, 1.0 second, 1.5 seconds, 2.0 seconds, etc. and a time-divided non-heating time interval, such as, 0.5 seconds, 1.0 second, 1.5 seconds, 2.0 seconds, etc. and transmit the heating electric current to the first soft electric heater 152 or the second soft electric heater 154 to perform the heating operation. Such an operation is capable of preventing the voltage and electric current from a sudden drop which significantly affects the normal operation for the camera module 130. The power allocating method has a purpose to maintain the best working efficiency for the camera module 130.

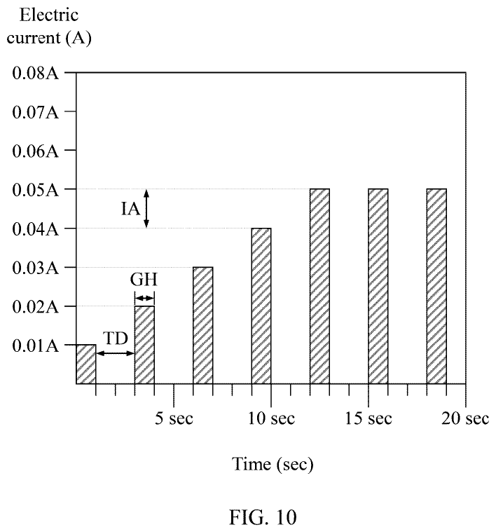

FIG. 10 is a schematic histogram illustrating the incremental change of the electric current per time-divided interval by the implementation of the electric current distributing step according to the present invention. For example, as shown in FIG. 10, in the electric current distributing step, it is assumed that the available redundant electric current is 0.1 A obtained by performing the redundant power estimation step, the gradually heating time interval GH is set to 1 second, the time-divided non-heating time interval TD is set to 2 seconds, and the incremental ratio IA is set to 10% until 50%. The MCU 1564 performs the operation including step to draw out the heating electric current in quantitative incremental basis from i.e., 10% of the redundant electric current, step to transmit the heating electric current to the first soft electric heater 152 or the second soft electric heater 154 within the gradually heating time interval GH lasting for 1 second, step to cease the transmission of the hearing electric current within the time-divided non-heating time interval TD every 2 seconds, step to cyclically repeat the above steps until the heating electric current rises up to the top of 0.05 A. The MCU 1564 keep performing the above operation with this time-divided and multiple segmented step mode to supply a heating electric current of 0.05 A lasting for 1 second to the first soft electric heater 152 or the second soft electric heater 154 per 2 seconds, until the space temperature rises up to 0° C., for example. By implementing this kind of mild-type power supply method, it is capable of preventing the voltage and electric current from a sudden drop which significantly affects the normal operation for the camera module 130, and maintaining the best working efficiency for the camera module 130.

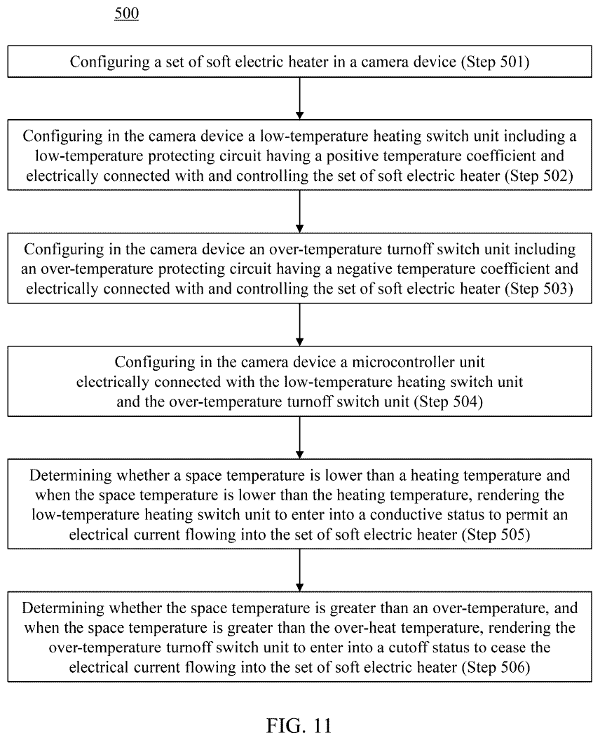

FIG. 11 is a flow chart showing the implementation steps for the camera device heating method according to the present invention. In summary, the camera device heating method 500 according to the present invention preferably includes, but not limited to, the following steps: configuring a set of soft electric heater in a camera device (Step 501); configuring in the camera device a low-temperature heating switch unit including a low-temperature protecting circuit having a positive temperature coefficient and electrically connected with and controlling the set of soft electric heater (Step 502); configuring in the camera device an over-temperature turnoff switch unit including an over-temperature protecting circuit having a negative temperature coefficient and electrically connected with and controlling the set of soft electric heater (Step 503); configuring in the camera device a microcontroller unit electrically connected with the low-temperature heating switch unit and the over-temperature turnoff switch unit (Step 504); determining whether a space temperature is lower than a heating temperature and when the space temperature is lower than the heating temperature, rendering the low-temperature heating switch unit to enter into a conductive status to permit an electric current flowing into the set of soft electric heater (Step 505); and determining whether the space temperature is greater than an over-temperature, and when the space temperature is greater than the over-heat temperature, rendering the over-temperature turnoff switch unit to enter into a cutoff state to cease the electric current flowing into the set of soft electric heater (Step 506).

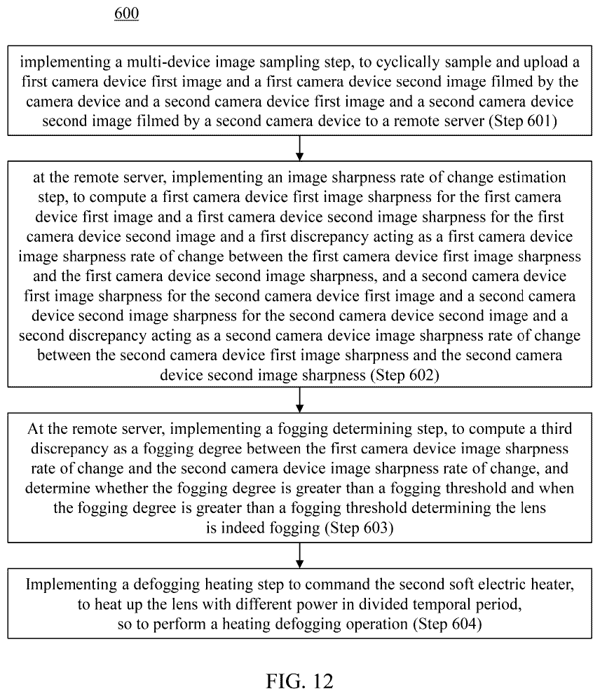

FIG. 12 is a flow chart showing the implementation steps for the fogging identifying method according to the present invention. In summary, the fogging identifying method 600 according to the present invention preferably includes, but not limited to, the following steps: implementing a multi-device image sampling step, to cyclically sample and upload a first camera device first image and a first camera device second image filmed by the camera device and a second camera device first image and a second camera device second image filmed by a second camera device to a remote server (Step 601); at the remote server, implementing an image sharpness rate of change estimation step, to compute a first camera device first image sharpness for the first camera device first image and a first camera device second image sharpness for the first camera device second image and a first discrepancy acting as a first camera device image sharpness rate of change between the first camera device first image sharpness and the first camera device second image sharpness, and a second camera device first image sharpness for the second camera device first image and a second camera device second image sharpness for the second camera device second image and a second discrepancy acting as a second camera device image sharpness rate of change between the second camera device first image sharpness and the second camera device second image sharpness (Step 602); at the remote server, implementing a fogging determining step, to compute a third discrepancy as a degree of fogging between the first camera device image sharpness rate of change and the second camera device image sharpness rate of change, and determine whether the degree of fogging is greater than a fogging threshold and when the degree of fogging is greater than a fogging threshold determining the lens is indeed fogging (Step 603); and implementing a defogging heating step to command the second soft electric heater, to heat up the lens with different power in divided temporal period, so to perform a defogging heating operation (Step 604).

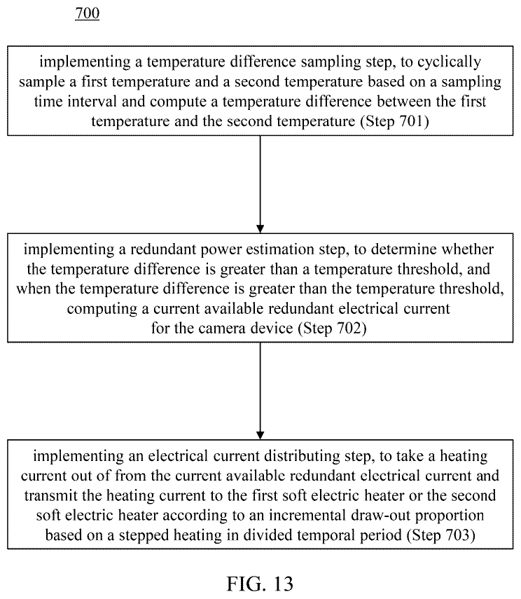

FIG. 13 is a flow chart showing the implementation steps for the power allocating method according to the present invention. In summary, the power allocating method 700 according to the present invention preferably includes, but not limited to, the following steps: implementing a temperature difference sampling step, to cyclically sample a first temperature and a second temperature based on a sampling time interval and compute a temperature difference between the first temperature and the second temperature (Step 701); implementing a redundant power estimation step, to determine whether the temperature difference is greater than a temperature threshold, and when the temperature difference is greater than the temperature threshold, computing a current available redundant electric current for the camera device (Step 702); and implementing an electric current distributing step, to take a heating current out of from the current available redundant electric current and transmit the heating current to the first soft electric heater or the second soft electric heater according to an incremental draw-out proportion based on a stepped heating in divided temporal period (Step 703).

There are further embodiments provided as follows.

Embodiment 1: A camera device heating module includes: a set of soft electric heater; and a control circuit block configured to electrically connected with and control the set of soft electric heater and including a low-temperature heating switch unit including a low-temperature protecting circuit having a positive temperature coefficient and connected with the set of soft electric heater; an over-temperature turnoff switch unit including an over-temperature protecting circuit having a negative temperature coefficient and connected with the set of soft electric heater; and a microcontroller unit electrically connected with the low-temperature heating switch unit and the over-temperature turnoff switch unit.

Embodiment 2: The camera device heating module as described in Embodiment 1, the set of soft electric heater further includes one of: a first soft electric heater configured at one side of an image processing module included in a camera device, wherein the image processing module includes an image signal processor; and a second soft electric heater configured at an unviewable area out of a field of view of a lens included in the camera device.

Embodiment 3: The camera device heating module as described in Embodiment 2, the first soft electric heater and the second first soft electric heater are flexible element; the first soft electric heater directly contacts a surface including the image signal processor selectively; the first soft electric heater is configured between the control circuit block and the image processing module, so to configure at one side of the image processing module; and the first soft electric heater is attached to the surface.

Embodiment 4: The camera device heating module as described in Embodiment 1, the low-temperature heating switch unit is configured to switch to enter into a conductive status to permit an electric current flowing into the set of soft electric heater when a space temperature is lower than a heating temperature; the over-temperature turnoff switch unit is configured to switch to enter into a cutoff state to cease the electric current flowing into the set of soft electric heater when a space temperature is greater than an over-heat temperature; the low-temperature heating switch unit takes over a power of control for the set of soft electric heater prior to the microcontroller unit, when the space temperature is lower than the heating temperature; the over-temperature turnoff switch unit takes over the power of control for the set of soft electric heater prior to the microcontroller unit, when the space temperature is greater than the over-heat temperature; and the microcontroller unit takes over the power of control for the set of soft electric heater prior to the low-temperature heating switch unit and the over-temperature turnoff switch unit, when the space temperature is in a range between the heating temperature and the over-heat temperature.

Embodiment 5: The camera device heating module as described in Embodiment 4, the heating temperature is selected from one of 0° C., 10° C., 20° C. and 30° C. and the over-temperature is selected from one of 50° C., 60° C., 70° C. and 80° C.

Embodiment 6: The camera device heating module as described in Embodiment 4, the control circuit block further includes one of: the low-temperature heating switch unit connected with the set of soft electric heater and including a positive temperature thermistor having the positive temperature coefficient to form the low-temperature protecting circuit; and the over-temperature turnoff switch unit connected with the set of soft electric heater and including a negative temperature thermistor having the negative temperature coefficient to form the over-temperature protecting circuit, wherein the low-temperature heating switch unit and the over-temperature turnoff switch unit have a circuit layout independent from that of the microcontroller unit, wherein the positive temperature thermistor is configured to have a Curie point temperature the same with that of the heating temperature, wherein the negative temperature thermistor is configured to have a Curie point temperature the same with that of the over-temperature.

Embodiment 7: A camera device includes: a lens; and a camera device heating module, including: a set of soft electric heater; and a control circuit block electrically connected with, configured to control the set of soft electric heater and including: a low-temperature heating switch unit including a low-temperature protecting circuit having a positive temperature coefficient and connected with the set of soft electric heater; an over-temperature turnoff switch unit including an over-temperature protecting circuit having a negative temperature coefficient and connected with the set of soft electric heater; and a microcontroller unit electrically connected with the low-temperature heating switch unit and the over-temperature turnoff switch unit.

Embodiment 8: The camera device as described in Embodiment 7, further includes one of: the lens having a viewable area with a field of view and an unviewable area without the field of view; an image processing module including an image signal processor; and the set of soft electric heater further including: a first soft electric heater configured at one side of the image processing module; a second soft electric heater configured at the unviewable area; and a light-transmittable protecting cover including a first surface, wherein the second soft electric heater is configured within the unviewable area by attaching to the first surface.

Embodiment 9: The camera device as described in Embodiment 8, the low-temperature heating switch unit is configured to switch to enter into a conductive status to permit an electric current flowing into the set of soft electric heater when a space temperature is lower than a heating temperature; the over-temperature turnoff switch unit is configured to switch to enter into a cutoff state to cease the electric current flowing into the set of soft electric heater when a space temperature is greater than an over-heat temperature; the low-temperature heating switch unit takes over a power of control for the set of soft electric heater prior to the microcontroller unit, when the space temperature is lower than the heating temperature; the over-temperature turnoff switch unit takes over the power of control for the set of soft electric heater prior to the microcontroller unit, when the space temperature is greater than the over-heat temperature; the microcontroller unit takes over the power of control for the set of soft electric heater prior to the low-temperature heating switch unit and the over-temperature turnoff switch unit, when the space temperature is in a range between the heating temperature and the over-heat temperature; the first soft electric heater and the second first soft electric heater are flexible element; the first soft electric heater directly contacts a surface including the image signal processor selectively; the first soft electric heater is configured between the control circuit block and the image processing module, so to configure at one side of the image processing module; and the first soft electric heater is attached to the surface.

Embodiment 10: The camera device as described in Embodiment 8, the control circuit block further includes one of: the low-temperature heating switch unit connected with the set of soft electric heater and including a positive temperature thermistor having the positive temperature coefficient to form the low-temperature protecting circuit; and the over-temperature turnoff switch unit connected with the set of soft electric heater and including a negative temperature thermistor having the negative temperature coefficient to form the over-temperature protecting circuit, wherein the low-temperature heating switch unit and the over-temperature turnoff switch unit have a circuit layout independent from that of the microcontroller unit, wherein the positive temperature thermistor is configured to have a Curie point temperature the same with that of the heating temperature, wherein the negative temperature thermistor is configured to have a Curie point temperature the same with that of the over-temperature.

Embodiment 11: A camera device heating method includes: configuring a set of soft electric heater in a camera device; configuring in the camera device a low-temperature heating switch unit including a low-temperature protecting circuit having a positive temperature coefficient and connected with and controlling the set of soft electric heater; configuring in the camera device an over-temperature turnoff switch unit including an over-temperature protecting circuit having a negative temperature coefficient and connected with and controlling the set of soft electric heater; and configuring in the camera device a microcontroller unit electrically connected with the low-temperature heating switch unit and the over-temperature turnoff switch unit.

Embodiment 12: The camera device heating method as described in Embodiment 11, further includes one of: determining whether a space temperature is lower than a heating temperature and when the space temperature is lower than the heating temperature, rendering the low-temperature heating switch unit to enter into a conductive status to permit an electric current flowing into the set of soft electric heater; determining whether the space temperature is greater than an over-temperature and when the space temperature is greater than the over-heat temperature, rendering the over-temperature turnoff switch unit to enter into a cutoff state to cease the electric current flowing into the set of soft electric heater; rendering the low-temperature heating switch unit to take over a power of control for the set of soft electric heater prior to the microcontroller unit, when the space temperature is lower than the heating temperature; rendering the over-temperature turnoff switch unit to take over the power of control for the set of soft electric heater prior to the microcontroller unit, when the space temperature is greater than the over-heat temperature; rendering the microcontroller unit to take over the power of control for the set of soft electric heater prior to the low-temperature heating switch unit and the over-temperature turnoff switch unit, when the space temperature is in a range between the heating temperature and the over-heat temperature; rendering the set of soft electric heater to include a first soft electric heater and a second first soft electric heater; configuring the first soft electric heater at one side of an image processing module included in the camera device, wherein the image processing module includes an image signal processor; rendering the first soft electric heater to directly contact a surface including the image signal processor included in the image processing module selectively; attaching the first soft electric heater to the surface; configuring the second soft electric heater at an unviewable area out of a field of view of a lens included in the camera device; configuring a positive temperature thermistor having the positive temperature coefficient connected with the set of soft electric heater in the low-temperature heating switch unit to form the low-temperature protecting circuit; configuring a negative temperature thermistor having the negative temperature coefficient connected with the set of soft electric heater in the over-temperature turnoff switch unit to form the over-temperature protecting circuit; rendering the low-temperature heating switch unit and the over-temperature turnoff switch unit to have a circuit layout independent from that of the microcontroller unit; configuring the positive temperature thermistor to have a Curie point temperature the same with that of the heating temperature; and configuring the negative temperature thermistor to have a Curie point temperature the same with that of the over-temperature.

Embodiment 13: The camera device heating method as described in Embodiment 11, the microcontroller unit is programmed to selectively execute a fogging identifying method, the fogging identifying method including one of: implementing a multi-device image sampling step, to cyclically sample and upload a first camera device first image and a first camera device second image filmed by the camera device and a second camera device first image and a second camera device second image filmed by a second camera device to a remote server; at the remote server, implementing an image sharpness rate of change estimation step, to compute a first camera device first image sharpness for the first camera device first image and a first camera device second image sharpness for the first camera device second image and a first discrepancy acting as a first camera device image sharpness rate of change between the first camera device first image sharpness and the first camera device second image sharpness, and a second camera device first image sharpness for the second camera device first image and a second camera device second image sharpness for the second camera device second image and a second discrepancy acting as a second camera device image sharpness rate of change between the second camera device first image sharpness and the second camera device second image sharpness; at the remote server, implementing a fogging determining step, to compute a third discrepancy as a degree of fogging between the first camera device image sharpness rate of change and the second camera device image sharpness rate of change, and determine whether the degree of fogging is greater than a fogging threshold and when the degree of fogging is greater than a fogging threshold determining the lens is fogging; and implementing a defogging heating step to command the second soft electric heater, to heat up the lens with different power in divided temporal period, so to perform a defogging operation.

Embodiment 14: The camera device heating method as described in Embodiment 11, the microcontroller unit is programmed to selectively execute a power allocating method, the power allocating method including one of: implementing a temperature difference sampling step, to cyclically sample a first temperature and a second temperature based on a sampling time interval and compute a temperature difference between the first temperature and the second temperature; implementing a redundant power estimation step, to determine whether the temperature difference is greater than a temperature threshold, and when the temperature difference is greater than the temperature threshold, computing a current available redundant electric current for the camera device; and implementing an electric current distributing step, to take a heating current out of from the current available redundant electric current and transmit the heating current to the first soft electric heater or the second soft electric heater according to an incremental draw-out proportion based on a stepped heating in divided temporal period.

While the disclosure has been described in terms of what are presently considered to be the most practical and preferred embodiments, it is to be understood that the disclosure need not be limited to the disclosed embodiments. On the contrary, it is intended to cover various modifications and similar arrangements included within the spirit and scope of the appended claims, which are to be accorded with the broadest interpretation so as to encompass all such modifications and similar structures. Therefore, the above description and illustration should not be taken as limiting the scope of the present disclosure which is defined by the appended claims.

While the disclosure has been described in terms of what are presently considered to be the most practical and preferred embodiments, it is to be understood that the disclosure need not be limited to the disclosed embodiments. On the contrary, it is intended to cover various modifications and similar arrangements included within the spirit and scope of the appended claims, which are to be accorded with the broadest interpretation so as to encompass all such modifications and similar structures. Therefore, the above description and illustration should not be taken as limiting the scope of the present disclosure which is defined by the appended claims.

What is claimed is:

1. A camera device heating module, comprising:
a set of soft electric heater; and
a control circuit block configured to electrically connected with and control the set of soft electric heater and comprising:
a low-temperature heating switch unit comprising a low-temperature protecting circuit having a positive temperature coefficient and connected with the set of soft electric heater;
an over-temperature turnoff switch unit comprising an over-temperature protecting circuit having a negative temperature coefficient and connected with the set of soft electric heater; and
a microcontroller unit electrically connected with the low-temperature heating switch unit and the over-temperature turnoff switch unit.

2. The camera device heating module as claimed in claim 1, wherein the set of soft electric heater further comprises one of:
a first soft electric heater configured at one side of an image processing module comprised in a camera device, wherein the image processing module comprises an image signal processor; and
a second soft electric heater configured at an unviewable area out of a field of view of a lens comprised in the camera device.

3. The camera device heating module as claimed in claim 2, wherein:
the first soft electric heater and the second first soft electric heater are flexible element;
the first soft electric heater directly contacts a surface comprising the image signal processor selectively;
the first soft electric heater is configured between the control circuit block and the image processing module, so to configure at one side of the image processing module; and
the first soft electric heater is attached to the surface.

4. The camera device heating module as claimed in claim 1, wherein:
the low-temperature heating switch unit is configured to switch to enter into a conductive status to permit an electric current flowing into the set of soft electric heater when a space temperature is lower than a heating temperature;
the over-temperature turnoff switch unit is configured to switch to enter into a cutoff state to cease the electric current flowing into the set of soft electric heater when a space temperature is greater than an over-heat temperature;
the low-temperature heating switch unit takes over a power of control for the set of soft electric heater prior to the microcontroller unit, when the space temperature is lower than the heating temperature;
the over-temperature turnoff switch unit takes over the power of control for the set of soft electric heater prior to the microcontroller unit, when the space temperature is greater than the over-heat temperature; and
the microcontroller unit takes over the power of control for the set of soft electric heater prior to the low-temperature heating switch unit and the over-temperature turnoff switch unit, when the space temperature is in a range between the heating temperature and the over-heat temperature.

5. The camera device heating module as claimed in claim 4, wherein the heating temperature is selected from one of 0° C., 10° C., 20° C. and 30° C. and the over-temperature is selected from one of 50° C., 60° C., 70° C. and 80° C.

6. The camera device heating module as claimed in claim 4, wherein the control circuit block further comprises one of:
the low-temperature heating switch unit connected with the set of soft electric heater and comprising a positive temperature thermistor having the positive temperature coefficient to form the low-temperature protecting circuit; and
the over-temperature turnoff switch unit connected with the set of soft electric heater and comprising a negative temperature thermistor having the negative temperature coefficient to form the over-temperature protecting circuit,
wherein the low-temperature heating switch unit and the over-temperature turnoff switch unit have a circuit layout independent from that of the microcontroller unit,
wherein the positive temperature thermistor is configured to have a Curie point temperature the same with that of the heating temperature,
wherein the negative temperature thermistor is configured to have a Curie point temperature the same with that of the over-temperature.

7. A camera device, comprising:
a lens; and
a camera device heating module, comprising:
a set of soft electric heater; and
a control circuit block electrically connected with, configured to control the set of soft electric heater and comprising:
a low-temperature heating switch unit comprising a low-temperature protecting circuit having a positive temperature coefficient and connected with the set of soft electric heater;
an over-temperature turnoff switch unit comprising an over-temperature protecting circuit having a negative temperature coefficient and connected with the set of soft electric heater; and
a microcontroller unit electrically connected with the low-temperature heating switch unit and the over-temperature turnoff switch unit.

8. The camera device as claimed in claim 7, further comprising one of:
the lens having a viewable area with a field of view and an unviewable area without the field of view;
an image processing module comprising an image signal processor; and
the set of soft electric heater further comprising:
a first soft electric heater configured at one side of the image processing module;
a second soft electric heater configured at the unviewable area; and
a light-transmittable protecting cover comprising a first surface, wherein the second soft electric heater is configured within the unviewable area by attaching to the first surface.

9. The camera device as claimed in claim 8, wherein:
the low-temperature heating switch unit is configured to switch to enter into a conductive status to permit an electric current flowing into the set of soft electric heater when a space temperature is lower than a heating temperature;
the over-temperature turnoff switch unit is configured to switch to enter into a cutoff state to cease the electric current flowing into the set of soft electric heater when a space temperature is greater than an over-heat temperature;
the low-temperature heating switch unit takes over a power of control for the set of soft electric heater prior to the microcontroller unit, when the space temperature is lower than the heating temperature;
the over-temperature turnoff switch unit takes over the power of control for the set of soft electric heater prior to the microcontroller unit, when the space temperature is greater than the over-heat temperature;
the microcontroller unit takes over the power of control for the set of soft electric heater prior to the low-temperature heating switch unit and the over-temperature turnoff switch unit, when the space temperature is in a range between the heating temperature and the over-heat temperature;
the first soft electric heater and the second first soft electric heater are flexible element;
the first soft electric heater directly contacts a surface comprising the image signal processor selectively;
the first soft electric heater is configured between the control circuit block and the image processing module, so to configure at one side of the image processing module; and
the first soft electric heater is attached to the surface.

10. The camera device as claimed in claim 8, wherein the control circuit block further comprises one of:
the low-temperature heating switch unit connected with the set of soft electric heater and comprising a positive temperature thermistor having the positive temperature coefficient to form the low-temperature protecting circuit; and
the over-temperature turnoff switch unit connected with the set of soft electric heater and comprising a negative temperature thermistor having the negative temperature coefficient to form the over-temperature protecting circuit,
wherein the low-temperature heating switch unit and the over-temperature turnoff switch unit have a circuit layout independent from that of the microcontroller unit,
wherein the positive temperature thermistor is configured to have a Curie point temperature the same with that of the heating temperature,
wherein the negative temperature thermistor is configured to have a Curie point temperature the same with that of the over-temperature.

11. A camera device heating method, comprising:
configuring a set of soft electric heater in a camera device;
configuring in the camera device a low-temperature heating switch unit comprising a low-temperature protecting circuit having a positive temperature coefficient and connected with and controlling the set of soft electric heater;
configuring in the camera device an over-temperature turnoff switch unit comprising an over-temperature protecting circuit having a negative temperature coefficient and connected with and controlling the set of soft electric heater; and
configuring in the camera device a microcontroller unit electrically connected with the low-temperature heating switch unit and the over-temperature turnoff switch unit.

12. The camera device heating method as claimed in claim 11, further comprising one of:
determining whether a space temperature is lower than a heating temperature and when the space temperature is lower than the heating temperature, rendering the low-temperature heating switch unit to enter into a conductive status to permit an electric current flowing into the set of soft electric heater;
determining whether the space temperature is greater than an over-temperature and when the space temperature is greater than the over-heat temperature, rendering the over-temperature turnoff switch unit to enter into a cutoff state to cease the electric current flowing into the set of soft electric heater;
rendering the low-temperature heating switch unit to take over a power of control for the set of soft electric heater prior to the microcontroller unit, when the space temperature is lower than the heating temperature;
rendering the over-temperature turnoff switch unit to take over the power of control for the set of soft electric heater prior to the microcontroller unit, when the space temperature is greater than the over-heat temperature;
rendering the microcontroller unit to take over the power of control for the set of soft electric heater prior to the low-temperature heating switch unit and the over-temperature turnoff switch unit, when the space temperature is in a range between the heating temperature and the over-heat temperature;
rendering the set of soft electric heater to comprise a first soft electric heater and a second first soft electric heater;
configuring the first soft electric heater at one side of an image processing module comprised in the camera device, wherein the image processing module comprises an image signal processor;
rendering the first soft electric heater to directly contact a surface comprising the image signal processor comprised in the image processing module selectively;
attaching the first soft electric heater to the surface;
configuring the second soft electric heater at an unviewable area out of a field of view of a lens comprised in the camera device;
configuring a positive temperature thermistor having the positive temperature coefficient connected with the set of soft electric heater in the low-temperature heating switch unit to form the low-temperature protecting circuit;
configuring a negative temperature thermistor having the negative temperature coefficient connected with the set of soft electric heater in the over-temperature turnoff switch unit to form the over-temperature protecting circuit;
rendering the low-temperature heating switch unit and the over-temperature turnoff switch unit to have a circuit layout independent from that of the microcontroller unit;
configuring the positive temperature thermistor to have a Curie point temperature the same with that of the heating temperature; and
configuring the negative temperature thermistor to have a Curie point temperature the same with that of the over-temperature.

13. The camera device heating method as claimed in claim 11, wherein the microcontroller unit is programmed to selectively execute a fogging identifying method, the fogging identifying method comprising one of:
implementing a multi-device image sampling step, to cyclically sample and upload a first camera device first image and a first camera device second image filmed by the camera device and a second camera device first image and a second camera device second image filmed by a second camera device to a remote server;
at the remote server, implementing an image sharpness rate of change estimation step, to compute a first camera device first image sharpness for the first camera device first image and a first camera device second image sharpness for the first camera device second image and a first discrepancy acting as a first camera device image sharpness rate of change between the first camera device first image sharpness and the first camera device second image sharpness, and a second camera device first image sharpness for the second camera device first image and a second camera device second image sharpness for the second camera device second image and a second discrepancy acting as a second camera device image sharpness rate of change between the second camera device first image sharpness and the second camera device second image sharpness;
at the remote server, implementing a fogging determining step, to compute a third discrepancy as a degree of fogging between the first camera device image sharpness rate of change and the second camera device image sharpness rate of change, and determine whether the degree of fogging is greater than a fogging threshold and when the degree of fogging is greater than a fogging threshold determining the lens is fogging; and
implementing a defogging heating step to command the second soft electric heater, to heat up the lens with different power in divided temporal period, so to perform a defogging operation.

14. The camera device heating method as claimed in claim 11, wherein the microcontroller unit is programmed to selectively execute a power allocating method, the power allocating method comprising one of:
implementing a temperature difference sampling step, to cyclically sample a first temperature and a second temperature based on a sampling time interval and compute a temperature difference between the first temperature and the second temperature;
implementing a redundant power estimation step, to determine whether the temperature difference is greater than a temperature threshold, and when the temperature difference is greater than the temperature threshold, computing a current available redundant electric current for the camera device; and
implementing an electric current distributing step, to take a heating current out of from the current available redundant electric current and transmit the heating current to the first soft electric heater or the second soft electric heater according to an incremental draw-out proportion based on a stepped heating in divided temporal period.
